(19) United States
(12) Patent Application Publication
(10) Pub. No.: US 2022/0289951 A1
(43) Pub. Date: Sep. 15, 2022

(54) VIBRATIONPROOF RUBBER COMPOSITION, VULCANIZED MOLDED BODY, AND VIBRATIONPROOF RUBBER

(71) Applicants: DENKA COMPANY LIMITED, Tokyo (JP); HONDA MOTOR CO., LTD., Tokyo (JP)

(72) Inventors: Hiroyuki Ishiguro, Tokyo (JP); Yasushi Abe, Tokyo (JP); Kazutaka Suzuki, Tokyo (JP); Keisuke Kawabe, Tokyo (JP)

(73) Assignees: DENKA COMPANY LIMITED, Tokyo (JP); HONDA MOTOR CO., LTD., Tokyo (JP)

(21) Appl. No.: 17/587,813

(22) Filed: Jan. 28, 2022

(30) Foreign Application Priority Data
Mar. 12, 2021 (JP) 2021-039974

(51) Int. Cl. C08L 11/00

(52) U.S. Cl. CPC C08L 11/00

(57) ABSTRACT

A vibrationproof rubber composition capable of obtaining a vibrationproof rubber having a specific hardness and an excellent balance of mechanical properties, vibrationproof properties, and a friction coefficient, a vulcanized molded body obtained by vulcanizing the vibrationproof rubber composition, and vibrationproof rubber is provided. A vibrationproof rubber composition comprising: 100 parts by mass of xanthogen-modified chloroprene rubber; 0.5 to 2 parts by mass of stearic acid amide; and 4 to 5 parts by mass of erucic acid amide, wherein: the vibrationproof rubber composition further comprises carbon black with an average primary particle diameter of 60 to 470 nm, and a molded body obtained by vulcanizing the vibrationproof rubber composition has a type A durometer hardness of 50 to 70 is provided.

### TECHNICAL FIELD

The present invention relates to a vibrationproof rubber composition comprising chloroprene rubber. In particular, it relates to a vibrationproof rubber composition comprising a specific amount of chloroprene rubber, stearic acid amide, and erucic acid amide, a vulcanized molded body obtained by vulcanizing the vibrationproof rubber composition, and vibrationproof rubber.

### BACKGROUND ART

Since chloroprene rubber has an excellent balance of physical properties such as mechanical properties, weather resistance, and flame resistance, and is easy to process, it is widely used as a raw material for industrial rubber parts such as various automotive members, belts, hoses, and vibrationproof rubber. For example, Patent Literature 1 discloses a vibrationproof rubber composition and a vibrationproof rubber comprising a rubber component and fine zinc oxide having a specific surface area in a specific range to improve the vibrationproof performance of the vibrationproof rubber. In addition, Patent Literature 2 discloses, in order to further improve heat resistance without impairing vibrationproof rubber properties and mechanical properties, a chloroprene rubber composition comprising active zinc oxide having a specific surface area and particle size, and carbon black having a specific particle size and DBP oil absorption amount.

### CITATION LIST

### Patent Literature

Patent Literature 1: JP-A-2006-193621

Patent Literature 2: JP-A-2014-227532

### SUMMARY OF INVENTION

### Technical Problem

In addition, depending on the application or where it is applied, a vibrationproof rubber may be required to have a certain degree of slipperiness against metal, i.e., a low friction coefficient. However, with the conventional technique, it has not been possible to obtain a vibrationproof rubber with a specific hardness and an excellent balance of mechanical properties, vibrationproof properties, and a friction coefficient.

The present invention has been made in view of such circumstances, and provide a vibrationproof rubber composition capable of obtaining a vibrationproof rubber having a specific hardness and an excellent balance of mechanical properties, vibrationproof properties, and a friction coefficient, a vulcanized molded body obtained by vulcanizing the vibrationproof rubber composition, and vibrationproof rubber, which is difficult to achieve with a conventional vibrationproof rubber composition.

### Solution to Problem

According to the present invention, a vibrationproof rubber composition comprising:

100 parts by mass of xanthogen-modified chloroprene rubber;

0.5 to 2 parts by mass of stearic acid amide; and

4 to 5 parts by mass of erucic acid amide, wherein: the vibrationproof rubber composition further comprises carbon black with an average primary particle diameter of 60 to 470 nm, and a molded body obtained by vulcanizing the vibrationproof rubber composition has a type A durometer hardness of 50 to 70 is provided.

The present inventors have conducted intensive studies and found that, by combining xanthogen-modified chloroprene rubber, stearic acid amide, and erucic acid amide in a specific ratio, further adding carbon black with an average primary particle diameter of 60 to 470 nm, and adjusting the hardness of the molded body obtained by vulcanizing the vibrationproof rubber composition to a specific numerical range, a vibrationproof rubber composition capable of obtaining a vibrationproof rubber having a specific hardness and an excellent balance of mechanical properties, vibrationproof properties, and a friction coefficient can be obtained, completing the present invention.

The following are examples of various embodiments of the invention. The embodiments shown below can be combined with each other.

Preferably, the vibrationproof rubber composition comprises 20 to 120 parts by mass of the carbon black with an average primary particle size of 60 to 470 nm with respect to 100 parts by mass of the xanthogen-modified chloroprene rubber.

Preferably, the carbon black with an average primary particle size of 60 to 470 nm comprises first carbon black with an average primary particle size of 60 to 80 nm and/or second carbon black with an average primary particle size of more than 80 nm and 470 nm or less.

Preferably, the vibrationproof rubber composition comprises 20 to 64 parts by mass of the first carbon black and/or 50 to 120 parts by mass of the second carbon black with respect to 100 parts by mass of the xanthogen-modified chloroprene rubber.

According to another aspect of the present invention, a vulcanized molded body obtained by vulcanizing the vibrationproof rubber composition is provided.

According to another aspect of the present invention, a vibrationproof rubber using the vulcanized molded body is provided.

### Effects of Invention

According to the vibrationproof rubber composition of the present invention, it is possible to obtain a vibrationproof rubber having a specific hardness and an excellent balance of mechanical properties, vibrationproof properties, and a friction coefficient. In particular, the obtained vibrationproof rubber utilizes its properties and can be used as various members that require vibrationproof properties. In particular, it can be used as a vibrationproof rubber for an automobile member, which is particularly required to have excellent mechanical properties, vibrationproof properties, and slipperiness against metal. Specifically, it can be used as a member for a bush, for example, a member for a compliance bush and a stabilizer bush.

### Mode for Carrying Out the Invention

Hereinafter, the present invention will be described in detail by exemplifying embodiments of the present invention. The present invention is not limited by these descriptions. The various features of the embodiments of the present invention shown below can be combined with each other. In addition, the invention can be made independently for each feature.

### 1. Vibrationproof Rubber Composition

The vibrationproof rubber composition of the present invention comprises 100 parts by mass of xanthogen-modified chloroprene rubber, 0.5 to 2 parts by mass of stearic acid amide, and 4 to 5 parts by mass of erucic acid amide.

The vibrationproof rubber composition of the present invention also comprises carbon black with an average primary particle diameter of 60 to 470 nm and a molded body obtained by vulcanizing the vibrationproof rubber composition has a type A durometer hardness of 50 to 70. Hereinafter, each component and properties will be described in detail.

### 1-1. Xanthogen-Modified Chloroprene Rubber

The chloroprene rubber of the present invention is a homopolymer of chloroprene or a copolymer of chloroprene and other monomers that can copolymerize with chloroprene. The monomer that can copolymerize with chloroprene is not particularly limited as long as the effect of the invention is not impaired. Examples of the monomer that can copolymerize with chloroprene include, for example, 2,3-dichloro-1,3-butadiene, 1-chloro-1,3-butadiene, styrene, acrylonitrile, m ethacrylonitrile, isoprene, butadiene, and acrylic acid, methacrylic acid, and their esters.

When a copolymer of chloroprene and other monomers that can copolymerize with chloroprene is used as chloroprene rubber, the copolymerization amount of the other monomer is preferably 50 parts by mass or less, and more preferably 30 parts by mass or less with respect to 100 parts by mass of chloroprene. By adjusting the copolymerization amount of the other monomers to this range, the effects of copolymerizing chloroprene with the other monomer can be achieved without impairing the properties of chloroprene rubber.

A chloroprene rubber is classified into mercaptan-modified type, xanthogen-modified type, and sulfur-modified type, depending on the molecular weight modifier used. The vibrationproof rubber composition according to the present invention contains xanthogen-modified chloroprene rubber. The xanthogen-modified chloroprene rubber can be obtained by using an alkyl xanthogen compound as a molecular weight modifier during manufacturing.

According to the present invention, by using the xanthogen-modified chloroprene, the vibrationproof rubber composition capable of obtaining vibrationproof rubber with an excellent balance of hardness, mechanical properties, vibrationproof properties, and a friction coefficient can be obtained.

### 1-2. Stearic Acid Amide and Erucic Acid Amide

The vibrationproof rubber composition of the present invention contains 0.5 to 2 parts by mass of stearic acid amide and 4 to 5 parts by mass of erucic acid amide with respect to 100 parts by mass of xanthogen-modified chloroprene rubber. The amount of stearic acid amide may be, for example, 0.5, 1.0, 1.5, 2.0 parts by mass, and may be within the range between any two of the numerical values exemplified here. Further, the amount of erucic acid amide may be, for example, 4.0, 4.2, 4.4, 4.5, 4.6, 4.8, 5.0 parts by mass, and may be within the range between any two of the numerical values exemplified here. According to the present invention, by blending xanthogen-modified chloroprene rubber, stearic acid amide, and erucic acid amide in a specific ratio, further adding carbon black, and adjusting the hardness of the vulcanized molded body, a vibrationproof rubber composition capable of obtaining a vibrationproof rubber having a specific hardness and an excellent balance of mechanical properties, vibrationproof properties, and a friction coefficient can be obtained,

The vibrationproof rubber composition of one embodiment of the present invention can also contain a fatty acid amide other than stearic acid amide and erucic acid amide as long as the effects of the present invention are not impaired. When the vibrationproof rubber composition of one embodiment of the present invention contains the fatty acid amide other than stearic acid amide and erucic acid amide, the amount of the fatty acid amide other than stearic acid amide and erucic acid amide with respect to 100 parts by mass of xanthogen-modified chloroprene rubber is preferably less than 10 parts by mass, more preferably less than 5 parts by mass.

### 1-3. Carbon Black

The vibrationproof rubber composition of the present invention contains carbon black with an average primary particle diameter of 60 to 470 nm. In other words, the raw material of the vibrationproof rubber composition of the present invention preferably contains carbon black with an average primary particle diameter of 60 to 470 nm. In addition, in the vibrationproof rubber composition according to one embodiment of the present invention, the average primary particle diameter of carbon black contained in the vibrationproof rubber composition is preferably 60 to 470 nm. Here, the average primary particle diameter of carbon black can be determined by observing with an electron microscope in accordance with JIS Z8901.

The vibrationproof rubber composition according to one embodiment of the present invention may contain one or more types of carbon black. The carbon black having an average primary particle diameter of 60 to 470 nm according to the present invention preferably includes first carbon black having an average primary particle diameter of 60 to 80 nm and/or a second carbon black having an average primary particle diameter of more than 80 nm and 470 nm or less.

The carbon black having an average primary particle diameter of 60 to 470 nm according to one embodiment of the present invention preferably may include the first carbon black having an average primary particle diameter of 60 to 80 nm. In other words, the raw material of the vibrationproof rubber composition according to one embodiment the present invention may contain the first carbon black having an average primary particle diameter of 60 to 80 nm. By including the first carbon black having an average primary particle diameter of 60 to 80 nm, the mechanical strength can be further improved.

Further, the carbon black having an average primary particle diameter of 60 to 470 nm according to one embodiment of the present invention can include second carbon black having an average primary particle diameter of more than 80 nm and 470 nm or less. In other words, the raw material of the vibrationproof rubber composition according to one embodiment of the present invention may contain the second carbon black having an average primary particle diameter of more than 80 nm and 470 nm or less.

Further, the carbon black having an average primary particle diameter of 60 to 470 nm according to one embodiment of the present invention may include a first carbon black having an average primary particle diameter of 60 to 80 nm and the second carbon black having an average primary particle diameter of more than 80 nm and 470 nm or less. In other words, the raw material of the vibrationproof rubber composition according to one embodiment of the present invention may contain the first carbon black having an average primary particle diameter of 60 to 80 nm and the second carbon having an average primary particle diameter of more than 80 nm and 470 nm or less.

The vibrationproof rubber composition according to one embodiment of the present invention comprises 20 to 120 parts by mass of carbon black with an average primary particle diameter of 60 to 470 nm with respect to 100 parts by mass of xanthogen-modified chloroprene rubber, and more preferably 50 to 100 parts by mass. The content of carbon black with an average primary particle diameter of 60 to 470 nm is, for example, 20, 30, 40, 50, 60 70, 80, 90, 100, 110, 120 parts by mass and may be within the range between any two of the numerical values exemplified here.

The vibrationproof rubber composition of one embodiment of the present invention preferably comprises 20 to 64 parts by mass of the first carbon black and/or 50 to 120 parts by mass of the second carbon black with respect to 100 parts by mass of the xanthogen-modified chloroprene rubber.

The content of the first carbon black may be, for example, 20, 30, 40, 50, 60, 64 parts by mass, a may be within the range between any two of the numerical values exemplified here. The content of the second carbon black may be, for example, 50, 60, 70, 80, 90, 100, 110, 120 and may be within the range between any two of the numerical values exemplified here.

When the vibrationproof rubber composition according to one embodiment of the present invention contains the first carbon black and the second carbon black, the blending ratio of the first carbon black and the second carbon black is 10 to 50: 90 to 50 by mass.

The vibrationproof rubber composition according to one embodiment of the present invention may use filler and reinforcing material other than the carbon black with an average primary particle diameter of 60 to 470 nm. When the total of the filler and reinforcing material contained in the vibrationproof rubber composition is 100 parts by mass, the vibrationproof rubber composition according to one embodiment of the present invention preferably comprises 60 parts by mass or more, and more preferably 80 parts by mass or more of the carbon black with an average primary particle diameter of 60 to 470 nm. The vibrationproof rubber composition according to one embodiment of the present invention may not contain the filler or reinforcing material other than the carbon black with an average primary particle diameter of 60 to 470 nm.

By adjusting the average primary particle size and the amount of carbon black contained in the vibrationproof rubber composition, the properties of the vulcanized molded body obtained by vulcanizing the vibrationproof rubber composition, especially the hardness and other mechanical properties, can be adjusted. Therefore, it is preferable to adjust the average primary particle size and the amount of carbon black according to the required hardness and other properties of the vibrationproof rubber. By adjusting the average primary particle size and blending amount of carbon black within the above range, the vibrationproof rubber composition capable of obtaining a vibrationproof rubber with a better balance of mechanical properties, vibrationproof properties and friction coefficient can be obtained.

### 1-4. Vulcanizing Agent

The vibrationproof rubber composition according to one embodiment of the present invention may further contain a vulcanizing agent. The type of the vulcanizing agent is not particularly limited as long as it does not impair the effect of the present invention, and one or more of the vulcanizing agents that can be used for chloroprene rubber can be freely selected and used. Examples of the vulcanizing agent, for example, include zinc oxide, magnesium oxide, lead oxide, trilead tetroxide, iron trioxide, titanium dioxide, calcium oxide, and hydrotalcite. The blending amount of the vulcanizing agent is also not particularly limited. In the vibrationproof rubber composition according to one embodiment of the present invention, it is preferable that the blending amount of the vulcanizing agent is 3 to 15 parts by mass with respect to 100 parts by mass of chloroprene rubber. When the vulcanizing agent is added within this range, processing safety can be ensured, and good vulcanization products can be obtained.

### 1-5. Vulcanization Accelerator

The vibrationproof rubber composition according to one embodiment of the present invention can be vulcanized even more effectively by using the aforementioned vulcanizing agent together with a vulcanization accelerator.

The type of the vulcanization accelerator that can be added to the vibrationproof rubber composition according to the present invention is not particularly limited as long as the effect of the present invention is not impaired, and one or more vulcanization accelerators generally used for vulcanization of chloroprene rubber can be freely selected and used. As the vulcanization accelerator, thiourea-based, guanidine-based, thiuram-based, and thiazole-based vulcanization accelerators can be added, and thiourea-based and thiuram-based accelerators are particularly preferable. Examples of the thiourea-based vulcanization accelerator include ethylenethiourea, diethylthiourea, trimethylthiourea, triethylthiourea, and N, N′-diphenylthiourea and trimethylthiourea and ethylene thiourea are particularly preferred. In addition, the vulcanization accelerator such as 3-methylthiazolidinedione-2, a mixture of thiadiazole and phenylenedimaleimide, dimethylammonium hydrogen isophthalate, and 1,2-dimercapto-1,3,4-thiadiazole derivative can also be used. In the vibrationproof rubber composition according to one embodiment of the present invention, the amount of the vulcanization accelerator added is preferably 0.5 to 5 parts by mass with respect to 100 parts by mass of the chloroprene rubber.

### 1-6. Antioxidant

Primary antioxidants are added mainly to suppress a decrease in durometer hardness, elongation at break, and to improve heat resistance when the obtained vulcanized molded body or vibrationproof rubber is heated. Examples of the primary antioxidant include phenol-based antioxidants, amine-based antioxidants, acrylate-based antioxidants, carbamic acid metal salts, and wax. These primary antioxidants may be used alone, or two or more kinds thereof may be used in combination. Among these compounds, amine-based antioxidants such as 4,4′-bis (α,α-dimethylbenzyl) diphenylamine, octylated diphenylamine, N-phenyl-N′-(1,3-dimethylbutyl) -p-phenylene diamine are preferable because they have a large effect of improving heat resistance.

The blending amount of the primary antioxidant may be 0.1 to 1.0 parts by mass, preferably 1 to 5 parts by mass with respect to 100 parts by mass of chloroprene rubber contained in the vibrationproof rubber composition. By setting the blending amount of the primary antioxidant within this range, a decrease in durometer hardness, elongation at break can be suppressed, and the heat resistance can be improved when the obtained vulcanized molded body or vibrationproof rubber is heated.

The secondary antioxidant is added mainly to suppress a decrease in durometer hardness, elongation at break, and compression set and to improve heat resistance when the obtained vulcanized molded body and vibrationproof rubber are heated. Examples of the secondary antioxidant include phosphorus-based antioxidants, sulfur-based antioxidants, and imidazole-based antioxidants. These secondary antioxidants may be used alone, or two or more of these can be used in combination. Among these compounds, phosphorus-based antioxidants such as tris(nonylphenyl)phosphite, tris(2,4-di-t-butylphenyl)phosphite, sulfur-based antioxidants such as thiodiopropionic acid dilauryl, dimistyl-3,3′-thiodipropionate, distearyl-3,3′-thiodipropionate, and imidazole antioxidant such as 2-mercaptobenzimidazole and 1-benzyl-2-ethylimidazole are preferred because they have a large effect of improving heat resistance.

The blending amount of the secondary antioxidant is 0.1 to 1.0 parts by mass, preferably 0.5 to 5 parts by mass, with respect to 100 parts by mass of the xanthogen-modified chloroprene rubber in the vibrationproof rubber composition. By setting the blending amount of the secondary antioxidant within this range, the durometer hardness, elongation at break, and compression set of the resulting vulcanized molded body and vibrationproof rubber can be reduced, and the heat resistance of them can be improved.

### 1-7. Plasticizer

The vibrationproof rubber composition according to one embodiment of the present invention can contain a plasticizer. The plasticizer is not particularly limited as long as it is a plasticizer compatible with chloroprene rubber. Examples of the plasticizer include, for example, vegetable oils such as rapeseed oil, phthalate plasticizers, DUP (diundecyl phthalate), DOS (dioctyl sebacate), DOA (dioctyl adipate), ester plasticizers, ether ester plasticizers, thioether plasticizers, aroma oils, naphthenic oils. They may be used alone, or two or more kinds thereof may be used in combination according to the properties required for the vibrationproof rubber composition. The blending amount of the plasticizer is preferably 5 to 50 parts by mass with respect to 100 parts by mass of the chloroprene rubber.

### 1-8. Processing aid

The vibrationproof rubber composition according to one embodiment of the present invention can contain a processing aid. Processing aids are added mainly to improve processing properties, such as to make the vibrationproof rubber composition easier to peel off from rolls, molding dies, extruder screws, and the like. Examples of the processing aid include fatty acids such as stearic acid or paraffinic processing aids such as polyethylene. The amount of the processing aid is preferably 0.1 to 5 parts by mass with respect to 100 parts by mass of chloroprene rubber.

### 1-9. Method of Manufacturing Vibrationproof Rubber Composition

The xanthogen-modified chloroprene rubber, stearic acid amide, erucic acid amide, carbon black, and other required components are kneaded at a temperature equal to or lower than the vulcanization temperature to obtain the vibrationproof rubber composition according to one embodiment of the present invention. Examples of the device for kneading the raw material components include a conventionally known kneading device such as a mixer, a banbury mixer, a kneader mixer, and an open roll.

### 1-10. Properties of the Vibrationproof Rubber Composition

The type A durometer hardness of the molded body obtained by vulcanizing the vibrationproof rubber composition according to the present invention may be 50 to 70, preferably 52 to 69. The type A durometer hardness is, for example, 50, 51, 52, 53, 54, 55, 56, 57, 58, 59, 60, 61, 62, 63, 65, 66, 67, 68, 69, 70, and may be in a range between any two of the values illustrated here. The type A durometer hardness can be measured at 23° C. with three vulcanized molded sheets stacked on top of each other in accordance with JIS K6253-3. The type A durometer hardness of the molded body obtained by vulcanizing the vibrationproof rubber composition can be controlled by adjusting the type and amount of components contained in the vibrationproof rubber composition, for example, the average primary particle diameter of carbon black contained in the vibrationproof rubber composition and its blending amount.

The tensile strength of the molded body obtained by vulcanizing the vibrationproof rubber composition according to the present invention is preferably 14 MPa or more preferably 14.5 MPa or more. The upper limit can be, for example, 18 MPa or less. The elongation at break of the molded body obtained by vulcanizing the vibrationproof rubber composition according to the present invention is preferably 370% or more, and 380% or more. The tensile strength and elongation at break of the molded body obtained by vulcanizing the vibrationproof rubber composition can be measured according to JIS K6251. The tensile strength and elongation at break of the molded body obtained by vulcanizing the vibrationproof rubber composition can be controlled by adjusting the type and amount of components contained in the vibrationproof rubber composition.

The dynamic magnification (Kd/Ks) of the molded body obtained by vulcanizing the vibrationproof rubber composition according to the present invention is preferably 2.40 or less and 2.35 or less. The lower limit can be, for example, 1.80 or more. The dynamic magnification can be obtained by measuring the dynamic spring constant (Kd) and static spring constant (Ks) under 23° C. conditions using cylindrical test pieces according to the general test conditions specified in JIS K 6386. The dynamic magnification (Kd/Ks) of the molded body obtained by vulcanizing the vibrationproof rubber composition can be controlled by adjusting the type and amount of components contained in the vibrationproof rubber composition.

The friction coefficient at 1 Hz and 0° C. of the of the molded body obtained by vulcanizing the vibrationproof rubber composition according to the present invention is preferably 1.1 or less and 1.0 or less. The lower limit can be, for example, 0.3 or more. In addition, the friction coefficient at 1 Hz and 70° C. of the of the molded body obtained by vulcanizing the vibrationproof rubber composition according to the present invention is preferably less than 0.9 and more preferably less than 0.8. The lower limit can be, for example, 0.4 or higher. The friction coefficient can be determined, for example, by a friction and wear tester using a molded rubber sheet with a thickness of 2 mm, and the specific test method is described in the Examples. The friction coefficient of the molded body vulcanized with the vibrationproof rubber composition can be controlled by adjusting the type and amount of components contained in the vibrationproof rubber composition. The friction coefficient of the of the molded body obtained by vulcanizing the vibrationproof rubber composition according to the present invention can be controlled by adjusting the type and amount of components contained in the vibrationproof rubber composition.

The properties of the molded body obtained by vulcanizing the above vibrationproof rubber composition according to the present invention can be evaluated using the vulcanized molded body obtained by vulcanizing the vibrationproof rubber composition of one embodiment according to the present invention at 160° C. for 20 minutes.

### 2. Vulcanized Molded Body

The vulcanized molded body according to one embodiment of the present invention is a vulcanized molded body obtained by vulcanizing the above vibrationproof rubber composition. The above vibrationproof rubber composition may be vulcanized after being molded into various shapes as desired, or the vibrationproof rubber composition may be vulcanized to obtain the vulcanized rubber in advance and then molded into various shapes. The methods of molding the vibrationproof rubber composition and the vulcanized rubber include a conventional press molding, extrusion molding, and calendar molding. The methods used in the normal rubber industry can be used.

The method of vulcanization of the vibrationproof rubber composition is not particularly limited. A method of vulcanizing by general steam vulcanization or UHF vulcanization to obtain rubber can be adopted. Steam vulcanization is a means for vulcanizing an unvulcanized vibrationproof rubber composition by applying pressure and temperature with steam gas as a heat medium. UHF vulcanization is a means for vulcanizing a vibrationproof rubber composition by irradiating it with microwaves. Further, during press vulcanization or injection molding, the vibrationproof rubber composition may be held inside the molding die to raise the mold temperature to the vulcanization temperature to vulcanize the molded body. The vulcanization temperature can be appropriately set depending on the formulation of the vibrationproof rubber composition and the type of the vulcanizing agent, and is usually preferably 140 to 220° C., more preferably 150 to 180° C. The vulcanization time can be, for example, 10 to 30 minutes.

### 3. Vibrationproof Rubber

The vibrationproof rubber according to one embodiment of the present invention uses the above-mentioned vulcanized molding body.

The vibrationproof rubber according to one embodiment of the present invention has an excellent balance of properties such as hardness, mechanical properties, vibrationproof properties, and slipperiness (friction coefficient), and can be used for various applications. The application of the vibrationproof rubber according to one embodiment of the present invention is not particularly limited, and the vibrationproof rubber according to one embodiment of the present invention can be used for any application freely selected. The vibrationproof rubber according to one embodiment of the present invention can be used as various members requiring vibrationproof, particularly as a vibrationproof rubber for automobile members. Specifically, the vibrationproof rubber according to one embodiment of the present invention can be suitably used as a member for a bush, particularly a member for a compliance bush and a stabilizer bush.

### EXAMPLES

The invention will be described in more detail based on the Examples below, but the invention is not to be construed as limited to these Examples.

### <Examples 1 to 8 and Comparative Examples 1 to 15>

The raw materials were mixed in the formulas shown in Tables 1 and 2 and further kneaded using two 8-inch open rolls to prepare sheets of rubber compositions with a thickness of 2.3 mm. The rubber compositions of Examples 1 to 8 and Comparative Examples 1 to 15 were produced. The obtained sheet was press-vulcanized under the conditions of 160° C., for 20 minutes and a pressure of 0.8 MPa to prepare a vulcanized molded body having a thickness of 2.0 mm.

The details of the raw materials for the rubber compositions are as follows Xanthogen-modified chloroprene rubber: DCR-66 (registered trademark), manufactured by Denka Company Limited

Mercaptan-modified chloroprene rubber: DCR-36 (registered trademark), manufactured by Denka Company Limited

Carbon black A: primary particle size 62 nm: manufactured by TOKAI CARBON CO., LTD., Seast SVH (registered trademark)

Carbon black B: primary particle size 450 nm: manufactured by Cancarb Limited, Thermax N-990 (registered trademark)

Carbon Black C: primary particle size 26 nm: manufactured by Asahi Carbon Co., Ltd., Asahi #70

Carbon black D: primary particle size 45 nm: manufactured by Asahi Carbon Co., Ltd., Asahi #60U

The other raw materials were commercially available products, respectively.

The primary particle diameter of carbon black was determined by measuring the circle equivalent diameters of 200 particles on a micrograph taken with an electron microscope in accordance with JIS Z8901 and calculating the arithmetic average value of them.

### <Evaluation Method>

The physical properties of the obtained vulcanized molded body were evaluated. The evaluation method is as shown below.

### (1) Tensile Strength and Elongation at Break

The tensile strength and elongation at break were measured in accordance with JIS K6251. A dumbbell-shaped No. 3 test piece was cut from a sheet of the vulcanized molded body and measurement was performed using a fully automatic rubber tensile tester (AGS H, manufactured by SHIMADZU CORPORATION) at 23° C. with a tensile speed of 500 mm/min.

### (2) Type A Durometer Hardness

In accordance with JIS K6253-3, the type A durometer hardness was measured at 23° C. with three sheets of the vulcanized molded body stacked on top of each other. The hardness tester used was Asker Rubber Hardness Tester Type A, manufactured by KOBUNSHI KEIKI CO.,LTD..

(3) Vibrationproof property (Dynamic magnification)

The dynamic magnification can be calculated by measuring the dynamic spring constant (Kd) and static spring constant (Ks) under 23° C. conditions using cylindrical test pieces in accordance with the general test conditions specified in JIS K 6386. A dynamic characteristic tester (KCH701-20, manufactured by SAGINOMIYA SEISAKUSHO, INC.) was used as the measuring device.

### (4) Friction Coefficient

The friction coefficient was measured using a testing machine manufactured by Bruker Corporation. As the rubber material for measuring the friction coefficient, a rubber sheet having a thickness of 2 mm was used. While pressing a friction element of the tip R6 (tip with a radius of 6 mm) against the rubber sheet with a load of 20 N, the rubber sheet was vibrated at ±25 mm in the direction perpendicular to the friction element to measure the friction coefficient at a predetermined frequency and temperature.

### [Table 1]

TABLE 1

| | | | Example | | | | | | | | Comparative Example | | | |
|---|---|---|---|---|---|---|---|---|---|---|---|---|---|---|
| | | | 1 | 2 | 3 | 4 | 5 | 6 | 7 | 8 | 1 | 2 | 3 | 4 |
| composition | xantogen-modified | | 100 | 100 | 100 | 100 | 100 | 100 | 100 | 100 | | 100 | 100 | 100 |
| | chloroprene rubber | | | | | | | | | | | | | |
| | mercaptan-modified | | | | | | | | | | 100 | | | |
| | chloroprene rubber | | | | | | | | | | | | | |
| | carbon black a (primary particle | | | | | | 20 | 50 | 64 | 24 | | | | |
| | diameter: 62 nm) | | | | | | | | | | | | | |
| | carbon black b (primary particle | | 100 | 100 | 100 | 100 | | | | 50 | 100 | 35 | 125 | 100 |
| | diameter: 450 nm) | | | | | | | | | | | | | |
| | carbon black c (primary | | | | | | | | | | | | | |
| | particle diameter 26 nm) | | | | | | | | | | | | | |
| | carbon black d (primary particle | | | | | | | | | | | | | |
| | diameter: 45 nm) | | | | | | | | | | | | | |
| | stearic acid | | 0.5 | 0.5 | 0.5 | 0.5 | 0.5 | 0.5 | 0.5 | 0.5 | 0.5 | 0.5 | 0.5 | 0.5 |
| | stearic acid amide | | 0.5 | 1 | 2 | 1 | 0.5 | 0.5 | 0.5 | 0.5 | 0.5 | 0.5 | 0.5 | 5 |
| | eric acid amide | | 5 | 5 | 5 | 4 | 5 | 5 | 5 | 5 | 5 | 5 | 5 | |
| | ethylene bisstearate amide | | | | | | | | | | | | | |
| | behenoate amide | | | | | | | | | | | | | |
| | paraffin wax | | | | | | | | | | | | | |
| | 4,4-bis {α, α-dimethylbenzyl) | | 1 | 1 | 1 | 1 | 1 | 1 | 1 | 1 | 1 | 1 | 1 | 1 |
| | diphenylamine | | | | | | | | | | | | | |
| | MgO | | 4 | 4 | 4 | 4 | 4 | 4 | 4 | 4 | 4 | 4 | 4 | 4 |
| | dioctyl sebacate | | 10 | 10 | 10 | 10 | 10 | 10 | 20 | 10 | 10 | 10 | 10 | 10 |
| | ZnO | | 5 | 5 | 5 | 5 | 5 | 5 | 5 | 5 | 5 | 5 | 5 | 5 |
| | trimethylchiurea | | 1.5 | 1.5 | 1.5 | 1.5 | 1.5 | 1.5 | 1.5 | 1.5 | 1.5 | 1.5 | 1.5 | 1.5 |
| | tetramethylthium disulfide | | 0.4 | 04 | 0.4 | 0.4 | 0.4 | 0.4 | 04 | 0.4 | 04 | 0.4 | 0.4 | 0.4 |
| | N-phenyl-N′-(1,3-dimethylbutyl)- | | 0.5 | 0.5 | 0.5 | 0.5 | 0.5 | 0.5 | 0.5 | 0.5 | 05 | 0.5 | 0.5 | 0.5 |
| | p-phenylenediamine | | | | | | | | | | | | | |
| properties of | tension strength (MPa) | | 15.2 | 148 | 14.8 | 15 3 | 15 9 | 16.8 | 17.2 | 16 2 | 13.7 | 14.8 | 15.5 | 144 |
| vulcanized | stretch growth (%) | | 410 | 392 | 415 | 378 | 475 | 528 | 540 | 430 | 367 | 682 | 375 | 367 |
| molded body | hardness (Durometer-A) | | 65 | 66 | 65 | 62 | 53 | 69 | 68 | 67 | 65 | 48 | 72 | 71 |
| (vulcanization | vibrationproof property | | 2.28 | 2.32 | 2.29 | 2.15 | 1 94 | 2.18 | 2.28 | 2.25 | 2.54 | 1.80 | 2.48 | 2.22 |
| condition: | (dynamic magnification) | | | | | | | | | | | | | |
| 160° C. | friction coefficient | 1 Hz 0° C. | 0.4 | 0.7 | 0.7 | 0.8 | 09 | 0.7 | 06 | 0.5 | 04 | 1.3 | 0.4 | 1.8 |
| 20 minutes) | | 1 Hz 70° C. | 0.5 | 0.7 | 0.6 | 0.8 | 0.8 | 06 | 0.6 | 0.6 | 0.5 | 1.0 | 0.5 | 0.8 |

TABLE 2

| | | | Comparative Example | | | | | | | | | | |
|---|---|---|---|---|---|---|---|---|---|---|---|---|---|
| | | | 5 | 6 | 7 | 8 | 9 | 10 | 11 | 12 | 13 | 14 | 15 |
| composition | xantogen-modified | | 100 | 100 | 100 | 100 | 100 | 100 | 100 | 100 | 100 | 100 | 100 |
| | chloroprene rubber | | | | | | | | | | | | |
| | mercaptan-modified | | | | | | | | | | | | |
| | chloroprene rubber | | | | | | | | | | | | |
| | carbon black a (primary | | | | | | | | | | | | |
| | particle diameter: 62 nm) | | | | | | | | | | | | |
| | carbon black b (primary | | 100 | 100 | 100 | 100 | 100 | 100 | 100 | 100 | 100 | | |
| | particle diameter: 450 nm) | | | | | | | | | | | | |
| | carbon black c (primary | | | | | | | | | | | 20 | |
| | particle diameter: 26 nm) | | | | | | | | | | | | |
| | carbon black d (primary | | | | | | | | | | | | 24 |
| | particle diameter: 45 nm) | | | | | | | | | | | | |
| | stearic acid | | 0.5 | 0.5 | 0.5 | 5.5 | 0.5 | 0.5 | 0.5 | 0.5 | 0.5 | 0.5 | 0.5 |
| | stearic acid amide | | | 2 | 1 | | | | | | | 0.5 | 0.5 |
| | eric acid amide | | 5 | 3 | 10 | | 5 | 5 | | | | 5 | 5 |
| | ethylene bisstearate amide | | | | | | 5 | | 5 | | | | |
| | behenoate amide | | | | | | | 5 | | 5 | | | |
| | paraffin wax | | | | | | | | | | 5 | | |
| | 4,4′-bis (α, α-dimetbylbenzyl) | | 1 | 1 | 1 | 1 | 1 | 1 | 1 | 1 | 1 | 1 | 1 |
| | diphenylamine | | | | | | | | | | | | |
| | MgO | | 4 | 4 | 4 | 4 | 4 | 4 | 4 | 4 | 4 | 4 | 4 |
| | dioctyl sebacate | | 10 | 10 | 10 | 10 | 10 | 10 | 10 | 10 | 10 | 10 | 10 |
| | ZnO | | 5 | 5 | 5 | 5 | 5 | 5 | 5 | 5 | 5 | 5 | 5 |
| | trimethylchiurea | | 1.5 | 1.5 | 1.5 | 1.5 | 1.5 | 1.5 | 1.5 | 1.5 | 1.5 | 1.5 | 1.5 |
| | tetramethylthium disulfide | | 0.4 | 0.4 | 0.4 | 0.4 | 0.4 | 0.4 | 0.4 | 0.4 | 0.4 | 0.4 | 0.4 |
| | N-phenyl-N′-(1,3-dimethylbutyl)- | | 0.5 | 0.5 | 0.5 | 0.5 | 0.5 | 0 5 | 05 | 0.5 | 0.5 | 0.5 | 0.5 |
| | p-phenylenediamine | | | | | | | | | | | | |
| properties of | tension strength (MPa) | | 15.0 | 15.0 | 12.7 | 14.9 | 14.1 | 12 8 | 14.1 | 14.1 | 14 6 | 16.5 | 16 3 |
| vulcanized | stretch growth (%) | | 383 | 366 | 406 | 327 | 420 | 427 | 332 | 361 | 354 | 526 | 532 |
| molded body | hardness (Durometer-A) | | 66 | 63 | 63 | 70 | 65 | 66 | 70 | 70 | 67 | 57 | 55 |
| (vulcanization | vibrationproof property | | 2.24 | 2.10 | 3.04 | 2.18 | 2.38 | 2.49 | 1.88 | 2.17 | 2.18 | 2.04 | 2.01 |
| condition: | (dynamic magnification) | | | | | | | | | | | | |
| 160° C. | friction coefficient | 1 Hz 0° C. | 0.6 | 1.6 | 0.4 | 1.6 | 0.6 | 0.6 | 1.3 | 1.2 | 1.2 | 1.2 | 1.2 |
| 20 minutes) | | 1 Hz 70° C. | 1.0 | 1.1 | 0.6 | 1.3 | 1.0 | 0.7 | 1.0 | 1.1 | 0.9 | 1.1 | 1.0 |

1. A vibrationproof rubber composition comprising:
100 parts by mass of xanthogen-modified chloroprene rubber;
0.5 to 2 parts by mass of stearic acid amide; and
4 to 5 parts by mass of erucic acid amide, wherein:
the vibrationproof rubber composition further comprises carbon black with an average primary particle diameter of 60 to 470 nm, and a molded body obtained by vulcanizing the vibrationproof rubber composition has a type A durometer hardness of 50 to 70.

2. The vibrationproof rubber composition of claim 1, wherein the vibrationproof rubber composition comprises 20 to 120 parts by mass of the carbon black with an average primary particle size of 60 to 470 nm with respect to 100 parts by mass of the xanthogen-modified chloroprene rubber.

3. The vibrationproof rubber composition of claim 1, wherein the carbon black with an average primary particle size of 60 to 470 nm comprises first carbon black with an average primary particle size of 60 to 80 nm and/or second carbon black with an average primary particle size of more than 80 nm and 470 nm or less.

4. The vibrationproof rubber composition of claim 3, wherein the vibrationproof rubber composition comprises 20 to 64 parts by mass of the first carbon black and/or 50 to 120 parts by mass of the second carbon black with respect to 100 parts by mass of the xanthogen-modified chloroprene rubber.

5. A vulcanized molded body obtained by vulcanizing the vibrationproof rubber composition of claim 1.

6. A vibrationproof rubber using the vulcanized molded body of claim 5.
